(19) United States
(12) Patent Application Publication
(10) Pub. No.: US 2012/0197528 A1
(43) Pub. Date: Aug. 2, 2012

(54) METHOD AND APPARATUS FOR TRANSMITTING A DATASET FROM A TOOL TO A RECEIVER

(75) Inventors: Trung Le, Celle (DE); Kersten Kraft, Celle (DE); Andreas Hartmann, Celle (DE); Thorsten D. Roessel, Celle (DE)

(73) Assignee: BAKER HUGHES INCORPORATED, Houston, TX (US)

(21) Appl. No.: 13/351,346

(22) Filed: Jan. 17, 2012

Related U.S. Application Data
(60) Provisional application No. 61/437,301, filed on Jan. 28, 2011.

(51) Int. Cl. G06F 15/00; G01V 5/04; G01V 1/40; G01V 3/18

(52) U.S. Cl. 702/7; 702/188; 702/6; 702/8

(57) ABSTRACT

Method and apparatus for transmitting a first data set from a tool to a receiver are provided. The method includes: obtaining a first plurality of measurements using the tool to form a first dataset; saving data from the first plurality of measurements that form the first dataset in non-volatile memory; transmitting first data-groups derived from the first dataset to the receiver, each of the first data-groups comprising different measurements of the formation; and storing in the non-volatile memory a storage position of a last transmitted first data-group. Upon restoration of a loss of communications that prevents transmission of all the first data-groups, determining the storage position of the last transmitted first data-group; and continuing the transmission of the first data-groups from the storage position of the first data-group last transmitted before the loss of communications.

### CROSS REFERENCE TO RELATED APPLICATIONS

This application claims the benefit of an earlier filing date from U.S. Provisional Application Ser. No. 61/437,301 filed Jan. 28, 2011, the entire disclosure of which is incorporated herein by reference.

### BACKGROUND

1. Field of the Invention

The invention disclosed herein relates to logging in a borehole and, in particular, to transmitting data from a logging tool.

2. Description of the Related Art

Boreholes are drilled into the earth for many applications such as hydrocarbon production, geothermal production, and carbon sequestration. In order to efficiently use expensive resources drilling the boreholes, it is important for analysts to acquire detailed and continuous information related to the geologic formations being drilled.

Resistivity imaging is one type of process for obtaining the detailed information. In resistivity imaging, the resistivity of a formation is measured as a function of depth of the borehole and angle around the borehole. Variations in the resistivity are plotted or displayed to provide an image of the formation penetrated by a borehole.

In a technique referred to as logging-while-drilling (LWD), resistivity imaging is performed by a resistivity logging tool disposed in a bottomhole assembly that generally includes a drill bit located at the distal end of a drill string. Thus, as the borehole is being drilled, resistivity images are obtained and transmitted to the surface of the earth during the drilling process. At the surface of the earth, the resistivity images can be recorded and displayed to the appropriate analysts for their analysis. It would be well received in the art if the reliability of transmission of the resistivity images from the resistivity logging tool to the surface of the earth could be improved.

### BRIEF SUMMARY

Disclosed is a method for transmitting a first dataset from a tool to a receiver, the method includes: obtaining a first plurality of measurements using the tool to form a first dataset; saving data from the first plurality of measurements that form the first dataset in non-volatile memory; transmitting first data-groups derived from the first dataset to the receiver, each of the first data-groups comprising different measurements; storing in the non-volatile memory a storage position of a last transmitted first data-group; upon restoration of a loss of communications that prevents transmission of all the first data-groups, determining the storage position of the last transmitted first data-group; and continuing the transmission of the first data-groups from the storage position of the first data-group last transmitted before the loss of communications.

Also disclosed is an apparatus for transmitting a first image from a tool to a receiver, the apparatus having: a tool configured to obtain a first plurality of measurements; a non-volatile memory disposed in the tool and configured to store the first plurality of measurements; and at least one processor configured to: form a first dataset from the first plurality of measurements; transmit first data-groups derived from the first dataset to the receiver, each of the first data-groups comprising different measurements of the formation; store in the non-volatile memory a storage position of a last transmitted first data-group; upon restoration of a loss of communications that prevents transmission of all the first data-groups, determining the storage position of the last transmitted first data-group; and continuing the transmission of the first data-groups from the storage position of the first data-group last transmitted before the loss of communications.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole tool disposed in a borehole penetrating the earth;

FIG. 2 depicts aspects of the downhole tool;

FIG. 3 depicts aspects of transmitting images from the downhole tool to a receiver with a loss of power;

FIG. 4 depicts aspects of transmitting images from the downhole tool to the receiver upon restoration of power following the loss of power;

FIG. 5 depicts aspects of sort matrices of values stored in non-volatile memory;

FIG. 6 depicts aspects of populating empty memory cells in the non-volatile memory with resistivity timestamp measurement values;

FIG. 7 depicts aspects of creating an new uncompressed image from part of an existing image not completely transmitted to the receiver and a new incoming image;

FIG. 8 illustrates a flow chart of aspects of management of the non-volatile memory in a real time imaging process;

FIG. 9 illustrates a flow chart of a start-up process of an electronic board in the downhole tool responsible for preparing a compressed data-set;

FIG. 10 depicts aspects of managing memory in an EEPROM in an electronic board in the downhole tool responsible for transmitting data to the surface;

FIG. 11 illustrates an example of a finding-process for error correction data blocks; and

FIG. 12 presents one example of a method for transmitting an image from a downhole tool to a receiver upon restoration of power following a loss of power.

### DETAILED DESCRIPTION

In conventional resistivity imagers, if power to a bottomhole assembly having a resistivity logging tool is lost, the measured resistivity data that is cached, but not yet transmitted to the surface of the earth, is also lost. If the measured resistivity data is transmitted in large groups, then the complete group of data is lost. The techniques disclosed herein solve this problem.

A detailed description of one or more embodiments of the disclosed apparatus and method presented herein by way of exemplification and not limitation with reference to the Figures.

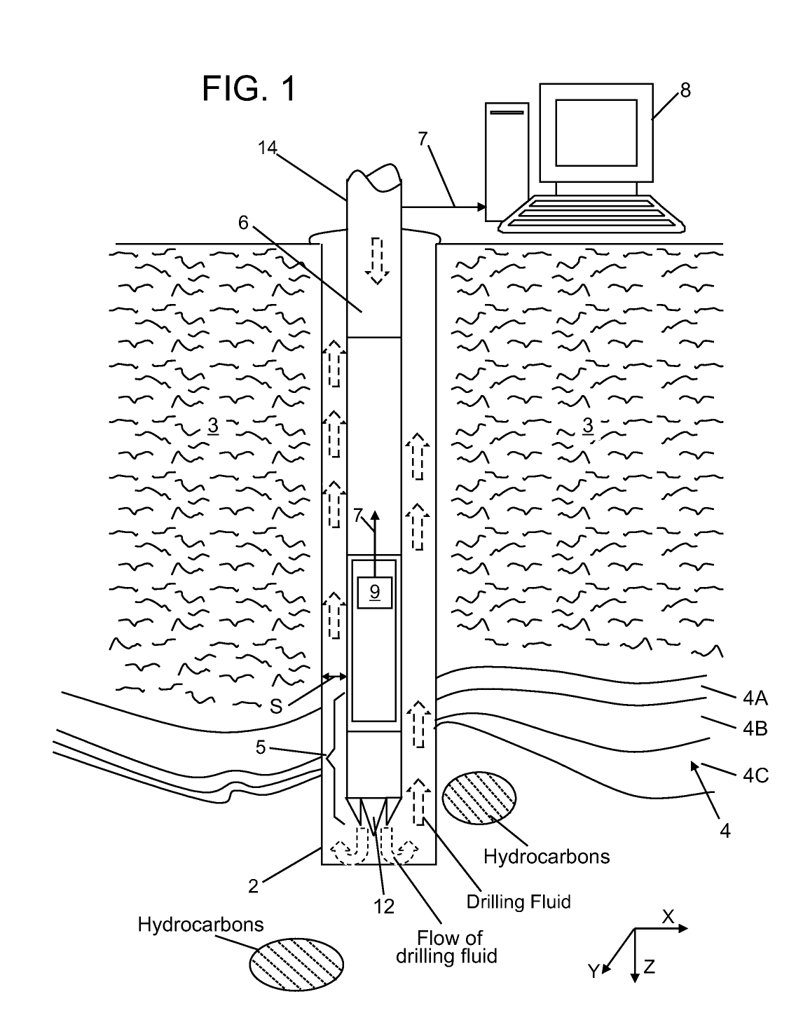

FIG. 1 illustrates an exemplary embodiment of a downhole tool 10 disposed in a borehole 2 penetrating the earth 3, which includes an earth formation 4. It is understood that the formation 4 can represent various materials of interest that may be present below the surface of the earth or in the borehole 2. The downhole tool 10 is included in a bottomhole assembly (BHA) 5 that includes a drill bit 12. In logging-while-drilling (LWD) or measurement-while-drilling (MWD) applications, the BHA 5 and, thus, the downhole tool 10 are conveyed through the borehole 2 by a carrier 14. In the embodiment of FIG. 1, the carrier 14 is a drill string 6. Thus, the downhole tool 10 can perform measurements while the borehole 2 is being drilled or during a temporary halt in drilling. In another embodiment, the carrier 14 can be an armored wireline for an application referred to as wireline logging. In wireline logging, the wireline supports and conveys the downhole tool 10 through the borehole 2.

Still referring to FIG. 1, the downhole tool 10 is configured to transmit data 7 to a receiver 8 disposed at the surface of the earth. The data 7 can represent a data stream used to transmit a data set, which may be referred to as an “image.” The receiver 8 is configured to receive and process the data 7, which can include recording the data 7 and displaying the data 7 in the form of an image. The data 7 is transmitted to the receiver 8 via a telemetry system 9. Non-limiting embodiments of the telemetry system 9 include pulsed-mud, wired drill pipe to transmit an electrical signal, optical, and acoustic.

For discussion purposes, the downhole tool 10 is configured to measure resistivity or its inverse conductivity. Non-limiting examples of types of measurements performed by the downhole tool 10 include gravity, density, porosity, radiation, formation fluid testing, spectroscopy, or nuclear magnetic resonance. The downhole tool 10 can be configured to perform measurements in open-hole or cased-hole applications.

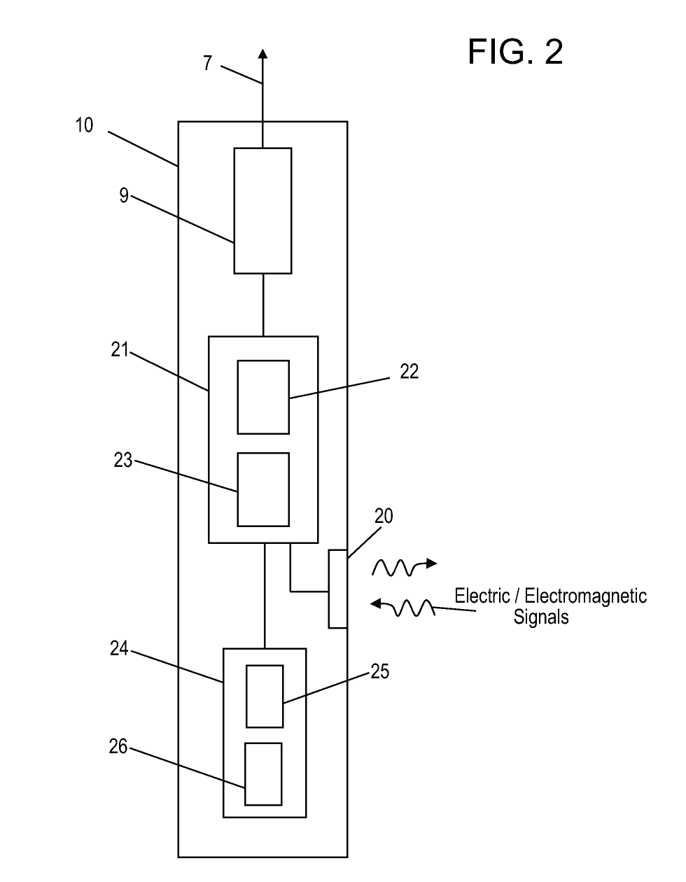

Reference may now be had to FIG. 2, which depicts aspects of the downhole tool 10 in more detail. For measuring the resistivity of the formation 4, the downhole tool 10 includes a sensor 20, which can be an electrode for galvanic measurements or an antenna or coil for induction measurements. The sensor 20 is coupled to a master unit 21. The master unit 21 includes electronics configured to transmit, receive and measure electrical or electromagnetic signals, which can include voltages or currents, using the sensor 20 as an interface with the formation 4. In addition, the master unit 21 is configured to process the associated measurement data. Also included in the master unit 21 is Electrically Erasable Programmable Read-Only Memory (EEPROM) 22, which is configured to operate in high temperatures experienced downhole.

Still referring to FIG. 2, the downhole tool 10 includes an imager 24 coupled to the master unit 21. The imager 24 is configured to perform real time image processing from the data related to the resistivity measurements. To perform the real time image processing, the imager 24 includes a digital signal processor (DSP) 25. In one embodiment, due to limited space within the downhole tool 10, the imager 24 includes only one non-volatile memory 26, which can be a NOR-Flash with one megabyte capacity.

The master unit 21 is further configured to provide the data 7 to the telemetry system 9 for transmission to the receiver 8. In order to insure that the receiver 8 correctly receives the data 7, the master unit 21 is configured to generate error correction data. The measured data and the error correction data together comprise an error correction block (ECB). The master unit 21 has processing capabilities to generate data groups, which are made up of bytes. The data groups are transmitted as the data 7. The data groups are used to form the ECB and, thus, a downhole image or data set and include groups of measurements performed by the downhole tool 10. An ECB module 23, as shown in FIG. 2, is configured to generate the ECB.

The techniques disclosed herein are discussed in further detail with respect to FIGS. 1 and 2. Resistivity values are measured and binned in the master unit 21 as a resistivity “timestamp.” In one embodiment, each resistivity timestamp has 120 sectors of measurements, which provide 3° azimuthal resolution, and is created every 0.5 seconds. Hence, in one embodiment, a resistivity timestamp has 120 measurements (i.e., a group of measurements) and is associated with a timestamp. Because some channels in the telemetry system 9 may have limited speed, the resistivity image needs to be compressed to be able to be transmitted it in real time. A discrete wavelet transformation (DWT) and Set Partitioning In Hierarchical Trees (SPIHT) algorithm is used to do the compressing in the imager 24. The resistivity timestamp is buffered to a bigger block so that the unprocessed image can have a time frame of up to several minutes. If there is enough information for processing a resistivity image, the uncompressed image is scaled and normalized before the DWT and the SPIHT is performed.

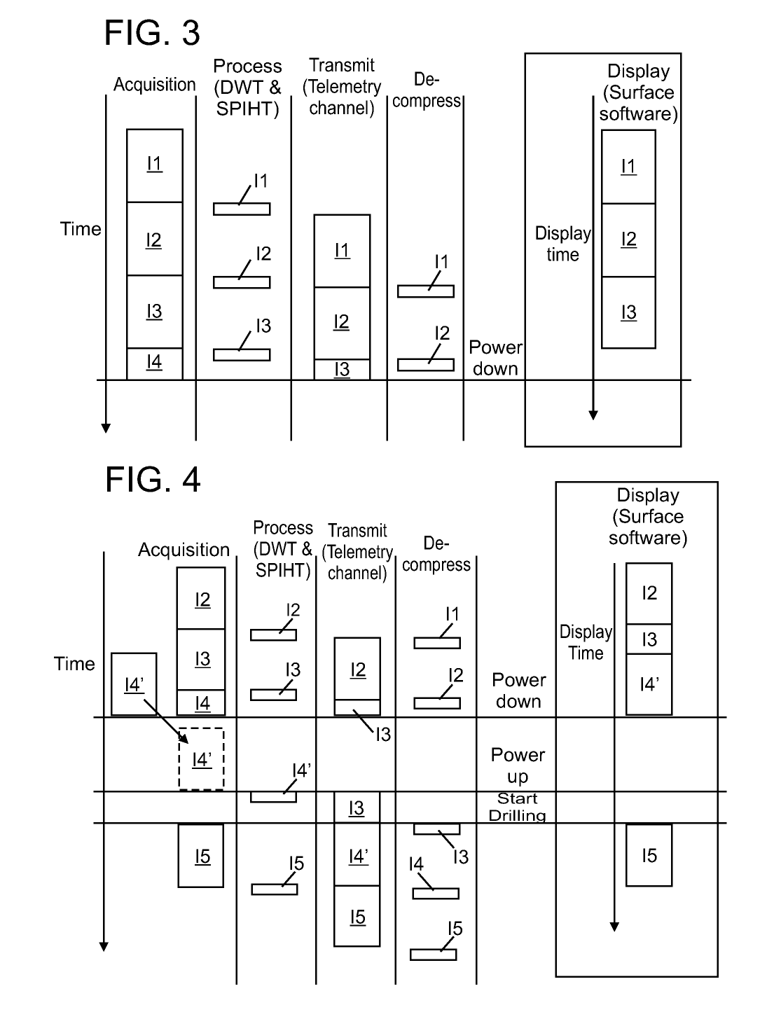

Because the compression cannot be done before the complete uncompressed image is received in the imager 24, all the information in this uncompressed image in the imager 24 is lost when power is lost to the BHA 5. Reference may now be had to FIG. 3, which demonstrates operation of a conventional resistivity logging tool upon loss of power. In FIG. 3, at the loss of power, Image 14 is lost completely. Image 13 has very low quality because there is not enough information to decompress the Image 13. To avoid losing detail in the formation image, the operator may wait before shutting down the power to the BHA until transmission of image 13 is completed. This waiting time may be done without drilling in a new formation so that Image 14, which is lost when power is lost, does not contain useful formation data. If this waiting is not done, gaps would occur in the realtime plot of Image 13 and the Image 14 would be lost. The techniques disclosed herein avoid having an image gap or requiring a wait time before drilling further into the formation 4.

Reference may now be had to FIG. 4, which demonstrates the concept of sending a recompressed image from the resistivity timestamps stored in the non-volatile memory 26. In FIG. 4, the Image 14′ is created from a part of the Image 13 and the rest of the Image 14. The Image 14′ is compressed directly after power is restored (i.e., power up). From the time of power up to the time when the BHA 5 starts drilling, the rest of the Image 13 will be sent. The longer the time the BHA 5 takes to start drilling, the higher the detail or resolution the Image 13 will have. The Image 14′ will be sent when the BHA 5 starts drilling again and will be on surface part of 13. The Image 14′ is created from resistivity timestamps, which are stored in the non-volatile memory 26 in the imager 24.

Channel coding is performed in the master unit 21 using a Reed Solomon algorithm. This is a block code, which contains five error correction bytes and ten data bytes for high, twenty for medium, and thirty for low correction level. Only when the complete ECB data group is received on the surface will the software in the receiver 8 start to decompress the transmitted image. Without the techniques disclosed herein, if the ECB data group is not completed before the new image comes in, the old image will be erased. In the case when power is lost, the rest of the information of Image 13 can be in a not-completed ECB data group. If the ECB data groups are not sent continuously, the rest of the Image 13 can also be lost. In a worst case, when the telemetry system 9 is so slow that an image frame is less than the data group generated by the ECB 23, Image 13 can be completely lost and even a part of Image 12 can be lost.

The imager 24, memory management in the imager 24, and startup of the imager 24 are now discussed in detail. As discussed above, the techniques call for saving the resistivity timestamp in the non-volatile memory 26 in the imager 24. After power is restored to the BHA 5 and, thus, to the master unit 21 and the imager 24, the DSP 25 loads the image stored in the non-volatile memory 26, creates a new uncompressed image, creates a new compressed image from the uncompressed image, and transmits the compressed image to the master unit 21.

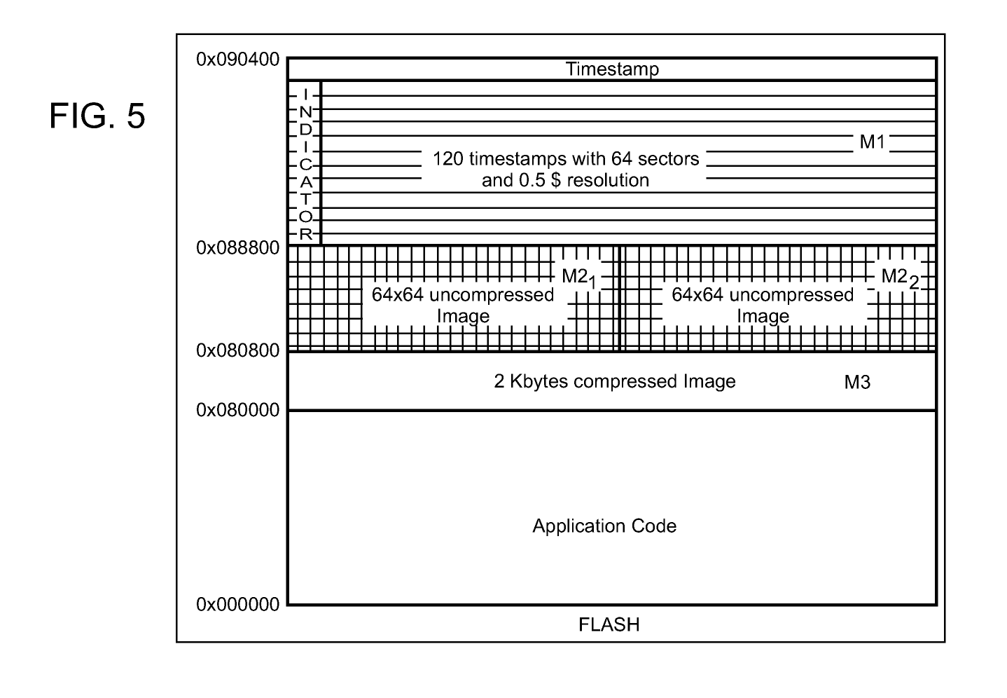

In one embodiment, there is only one non-volatile memory 26, which is the NOR-Flash with one megabyte capacity. This component is also used to store application code of the DSP 25, which has a size of about 300 kilobytes for one example of firmware. To accommodate future changes, the first part of the NOR-Flash (500 kilobytes) is reserved for the application code. The rest of the memory capacity is used for the techniques disclosed herein for transmitting images after restoration of power without losing images or image quality. In one embodiment, there are three sort matrices of values that are saved in the NOR-Flash—M1, M2, and M3 as shown in FIG. 5.

The M1 sort matrix contains 120 rows of timestamps (64×4 bytes). This saves the last minute in an image after binning. The maximal sectors of the image are 64 bytes and the values saved in float format are 32 bits. This string is always calculated for the real time imaging process and is additionally saved in the NOR-Flash. After one minute, the matrix is erased. The first row of this matrix is the start resistivity timestamp of the measured data. Each resistivity timestamp has a byte to indicate if it is empty (0xFF) or not empty (0x00). The size of the M1 matrix is 121×(64×4+1) or about 31 kilobytes

The M2 matrix is a 64×64 matrix of float values. This saves the uncompressed image, where 64×64 is the maximal size of an image. Memory is needed for two images, one for the completed uncompressed image and one for the incoming image. This matrix is calculated in real time during the imaging process at the moment. The result is saved only in RAM, not in the NOR-Flash. If the incoming image matrix is filled, the second one will be erased. The size of the two image matrices is 2×M2=2×64×64×4=32 kilobytes.

The M3 matrix has 2048 bytes (i.e., about two kilobytes), which saves the compressed image. It is a bit frame with timestamp header.

The total size of these matrices is about 65 kilobytes, which is less than the available 512 kilobytes in the NOR-Flash.

A critical point of the NOR-Flash is that it can only be overwritten about one million times. After that, the NOR-Flash is corrupted. M1 updates every one minute. With the number of overwrite cycles of one million, the M1 matrix can be used for 10⁶ minutes or about sixteen thousand hours. It is more than the working number of hours of some imager boards, which are specified for one thousand hours. M2 updates in the worst case every eight seconds (for smallest image format of 8×8 and shortest time resolution of one second). Using a calculation similar to the one for M1, it is determined that M2 can be used for about two thousand hours. M3 updates also in worst case every eight seconds. Similar to the M2 calculation, it is determined that M3 can be used for over two thousand hours. With the above described memory management, the NOR-Flash can be used with the imager 24.

The startup sequence of the imager 24 is now discussed. After the downhole tool 10 is powered up, the DSP 25 loads the matrix M3 and sends it to the master unit 21 (first step). This matrix contains all information for the image 13 as shown in FIG. 4. This image is sent in the time from power-on to the beginning of drilling.

The second step is to find the last incoming rows of the image 14 in the M1 matrix. Even with the longest time resolution of thirty seconds, all of the resistivity time stamps of the last rows are contained in this image in M1. Because the time resolution is stored in the master unit 21, the DSP 25 in the imager 24 knows the number of resistivity timestamps there are in an image row. If the last row of the incoming image is not filled, then the last resistivity timestamp is copied to fill the rest of this row. Hence, the techniques call for simulating that the tool 10 is off the bottom of the borehole 2 from power-off to the end of the last row (maximum of thirty seconds).

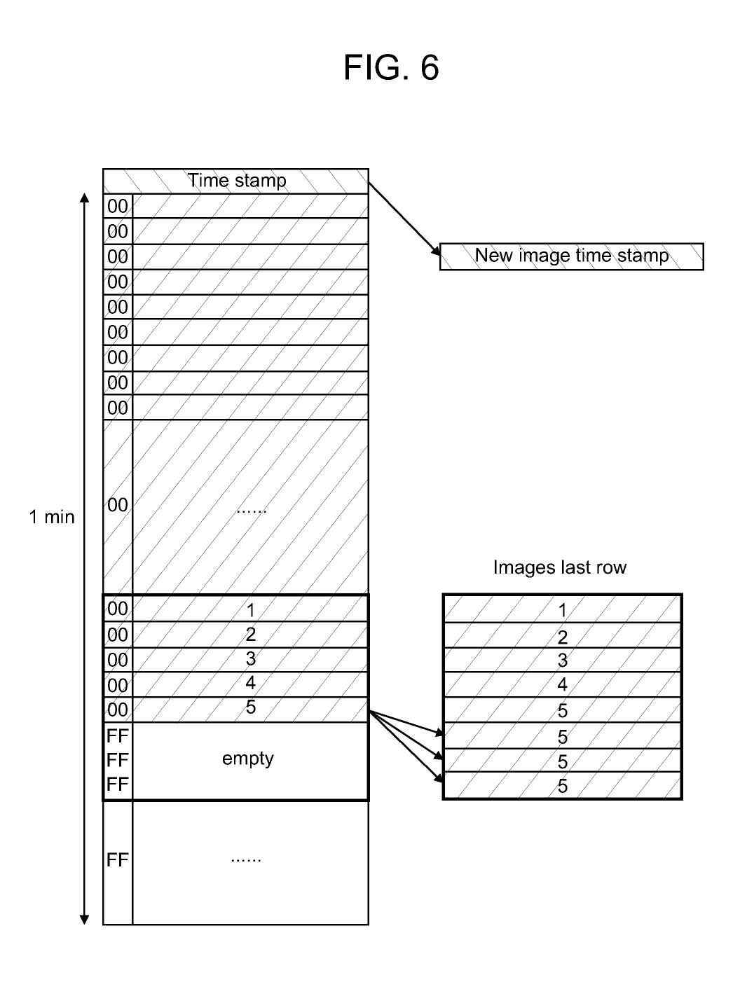

Reference may now be had to FIG. 6, which illustrates an example of creating a last image row in M1 for a four-second image. In this case, the first five locations of the last row in M1 are filled with five resistivity timestamps, the remaining three locations are empty. After starting up (i.e., after power restoration), the DSP 25 in the imager 24 loads the matrix M1, which is on the left in FIG. 6. Depending on the indicator type (0x00 or 0xFF), the DSP 25 can find the last resistivity timestamp. The number of resistivity timestamps can be calculated from the resistivity timestamps in M3 and M1. Therefore, information related to how long an image is or the number of rows used to make the image is known. The last resistivity timestamp in the fifth location (i.e., location number 5) is copied and used to fill in the last three locations in the last image row in M1 as shown in FIG. 6.

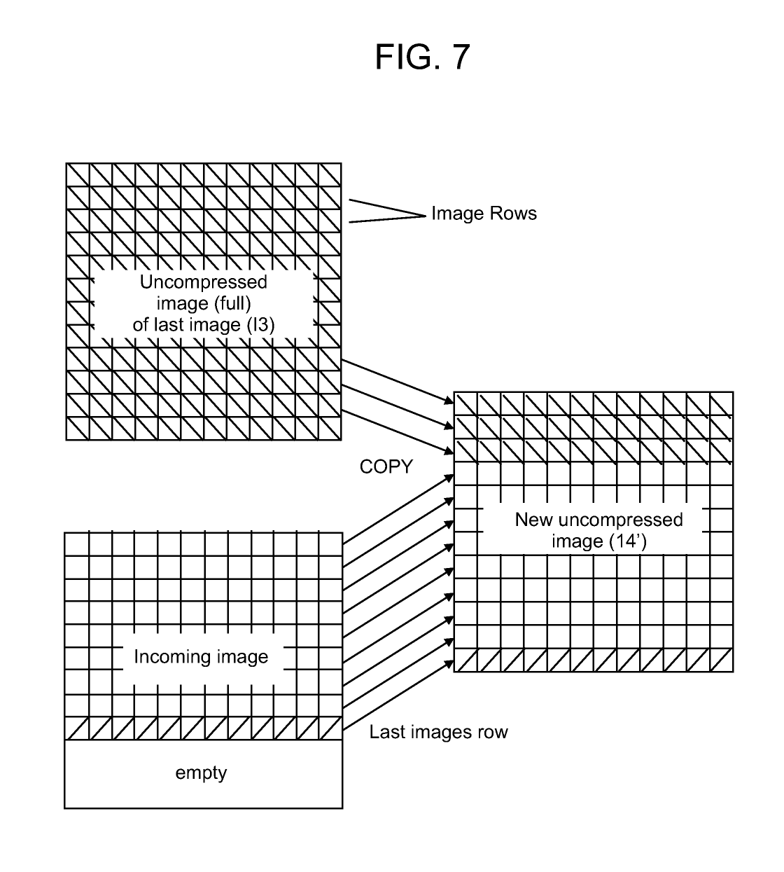

The last image row in M1 is averaged and added to the incoming uncompressed image in M2. This incoming portion of M2 is not filled. From this last image, the corresponding number of rows in an image is copied in a new uncompressed image as shown in FIG. 7. FIG. 7 depicts aspects of creating a new uncompressed image 14′ from the two matrices in M2. After the uncompressed image of 14′ is created, the DSP 25 in the imager 24 compresses this image and sends it to the master unit 21. The master unit 21 then sends the compressed image uphole to the processing unit 8 when the BHA starts to drill.

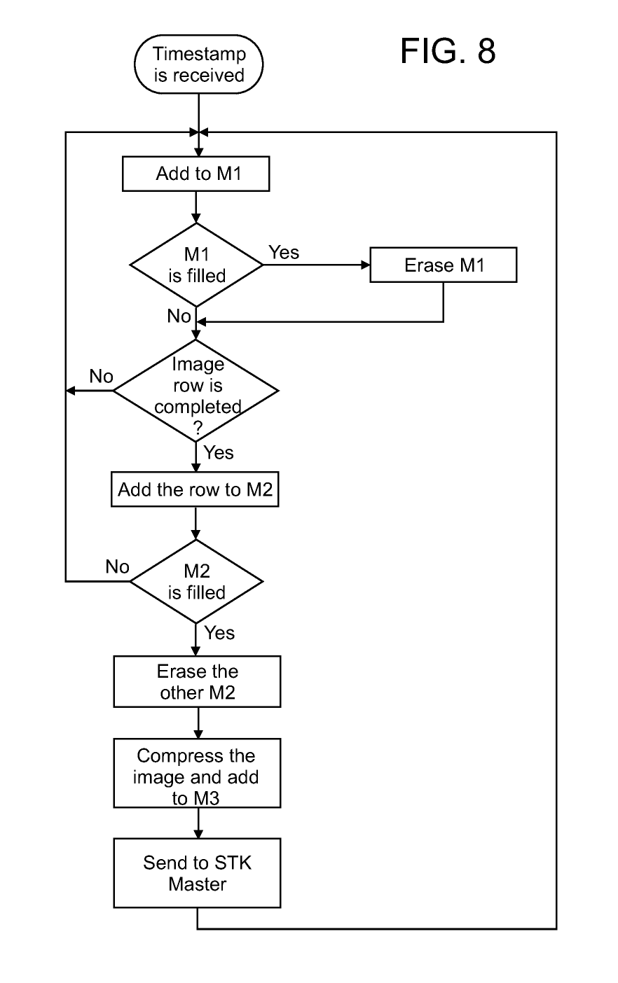

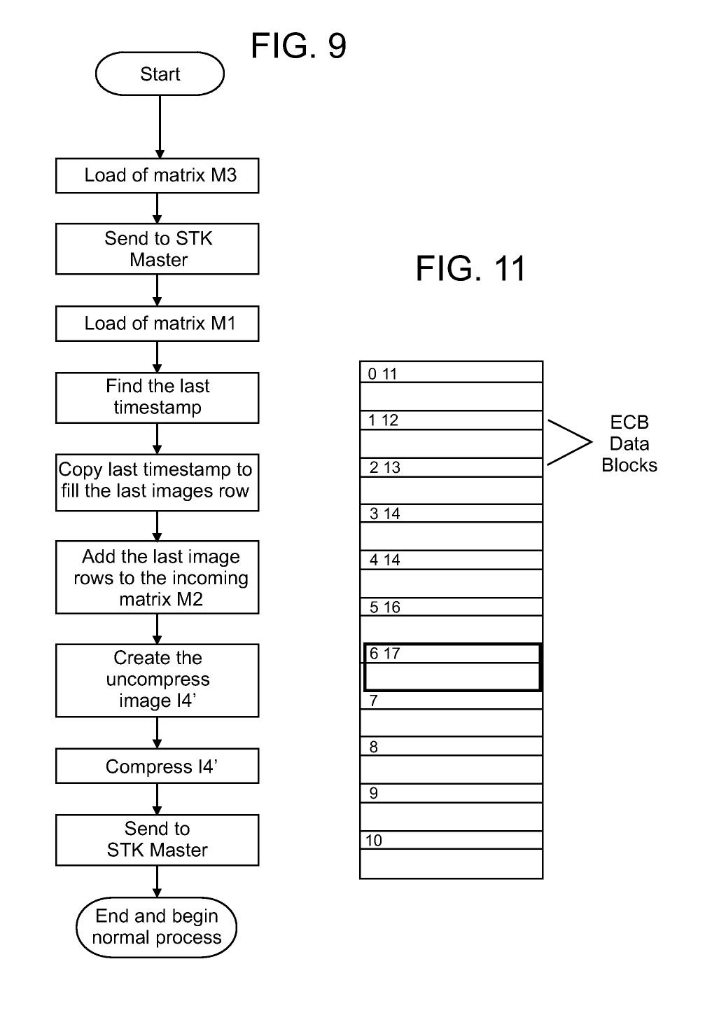

FIG. 8 illustrates a flow chart of the real time imaging process discussed above. FIG. 9 illustrates a flow chart of the start-up process of the imager 24 discussed above.

The master unit 21, error correction block storage in the EEPROM 22, and a start-up process of the master unit 21 are now discussed in detail. The master unit 21 includes the main measurement board for measuring voltages and currents related to measuring the resistivity of the formation 4. The master unit 21 is also a transport center to all internal components of the downhole tool 10 and to the receiver 8 at the surface of the earth 3. During the real time imaging process, the resistivity timestamps are transmitted to memory for storage and to the imager 24 to do the real time imaging process that includes the DWT and the SPIHT. After an image is compressed, the image is sent back to the master unit 21. The master unit 21 builds the coding channel (using the Reed Solomon algorithm) and the compressed image data is transmitted uphole in blocks or data-groups of error correction data generated by the ECB 23.

For the techniques disclosed herein, the master unit 21 receives the compressed image 13 from the imager 24 after restoration of power. This compressed image is added to the ECB 23, which was calculating error correction data before loss of power and before the image was sent uphole. Therefore, it is necessary for the ECB 23 to have the following information: what was the source of data for the ECB 23, what was the position of the data point before loss of power, and how many data bytes were already added to the ECB 23. All of this information must be stored in non-volatile memory in the master unit 21 or it will be lost after a power loss. The EEPROM 22 is non-volatile memory in the master unit 21 and in one embodiment has a 32 kilobyte capacity. Boot code for the DSP 25 and a table of calibration values are also stored in the EEPROM 22. When the EEPROM 22 has the 32 kilobyte size, only one kilobyte of free space is available to save the information for the ECB 23 before power-off.

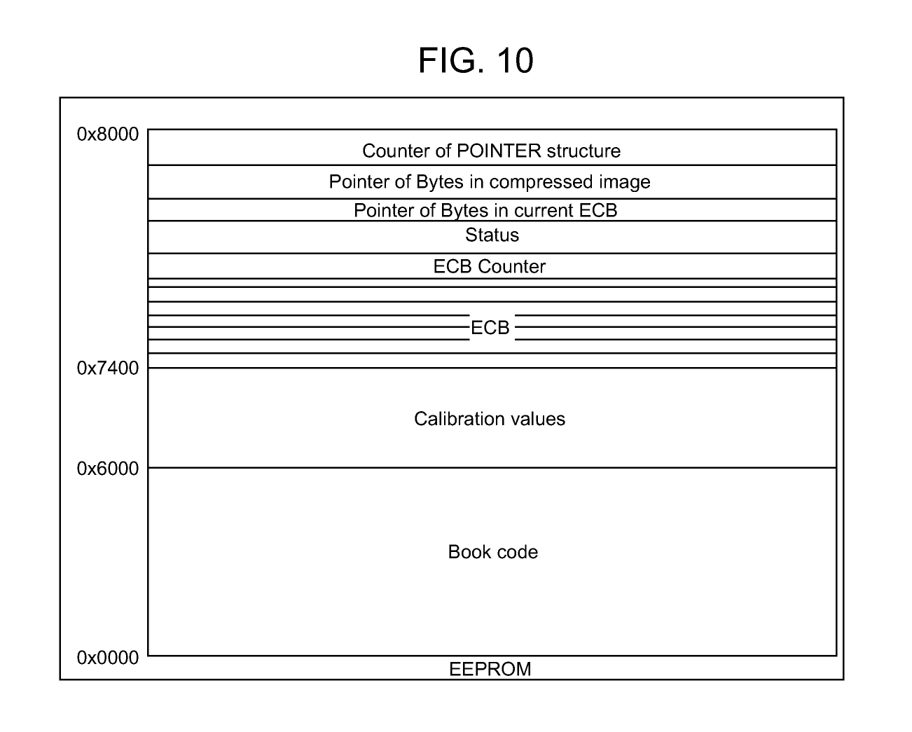

In one embodiment, the EEPROM 22 can only be overwritten about 300,000 times before it is corrupted. Therefore, the techniques disclosed herein present a method for saving the information for the ECB 23 with reference to FIG. 10.

After power-on, the position of the last data byte in the compressed image (in the matrix M3) and in the current ECB are stored in the EEPROM 22 so that the DSP 25 can find those positions, read the correct byte in the compressed image, and calculate the ECB data correctly. Therefore, besides the structure for the ECB, there is a pointer structure with two pointers, one on the Matrix M3 and one on the ECB data blocks, in the EEPROM 22.

If the same memory cell is updated every time a new ECB calculation starts, the EEPROM 22 with 300,000 overwrite cycle capacity can only work for a few days. Thus, the method disclosed for limiting the number of overwrite cycles calls for storing a buffer of the ECB information so that the EEPROM 22 will not be updated (i.e., overwritten) very often. To find the current position, a counter is also stored. The counter continuously increments when the structure in the EEPROM 22, the ECB 23, or the pointer is updated. The ECB data structure has two bytes for a counter and thirty data bytes (maximum block size). The total of the ECB data structure is 32 bytes. The pointer structure has two bytes for a counter, two bytes for a pointer on the matrix M3, one byte for a pointer on the ECB 23, and one byte for a status. The total size of the pointer structure is six bytes.

If there is one kilobyte of free space in the EEPROM 22, it is possible to have 11 ECBs with a total size of 11×32=352 bytes and 112 pointers with a total size of 112×6=672 bytes.

With a telemetry rate of over 30 bit/sec or 4 bytes/sec in one embodiment, the pointers will be updated each ¼ second, after a byte is transmitted to the surface of the earth 3. A memory cell in the pointer structure will be updated every 112/4=28 seconds.

There are four levels of correction:

no correction;

low correction with 30 data bytes and 5 error correction bytes;

medium correction with 20 data bytes and 5 error correction bytes; and

high correction with 10 data bytes and 5 error correction bytes.

With no correction, ECB data is not important to save because surface software in the receiver 8 does not need to synchronize. When only 10 of 30 bytes of ECB structure in the EEPROM 22 are written for high correction, the memory cell in the EEPROM 22 will be updated more often. Therefore, the usability of the EEPROM 22 ECB data will be calculated for this case. ECB data will be updated after all 11 ECBs are filled. A memory cell in the EEPROM 22 is updated every 10×11/4=27.5 seconds.

The memory cell for ECB data is more often updated than the memory cell for the pointer structure. When a memory cell can be overwritten 300,000 times, the usability of the EEPROM 22 is 300,000×27.5˜2291 hours. With a telemetry rate of 64 bits/second, the memory can be used for more than the 1000 hour rating of some electronic boards in one embodiment.

The start-up process of the master unit 21 is now discussed. At the beginning upon restoration of power, the master unit 21 receives the compressed image 13 from the imager 24. The ECB data and pointer data are loaded into RAM (random access memory) and the DSP 25 starts to find the current position of the ECB data and the pointer. Because the counter increments continuously, if the DSP 25 finds a jump in the counter, the jump marks the position of the current structure. With this information, the current ECB data, which was not transmitted to the receiver 8, can be reconstructed.

The fact that count 2¹⁶−1 in the counter is followed by count 0 is also addressed. Otherwise, the DSP 25 can interpret this jump as a normal jump resulting in a wrong current structure. All further processes require correct ECB data. A wrong block of ECB data can cause the transmission of ECB data with the surface software to become unsynchronized with the inherent loss of information of the real time image.

FIG. 11 illustrates an example of a finding-process for ECB data blocks or structures. Power-off occurs after the writing of the ECB data block 17. This ECB data block overwrites the ECB data block 6. The next ECB data block should be ECB data block 18, which would overwrite ECB data block 7 if the power-off did not occur. After power-on, the DSP 25 will find the jump from ECB data block 17 to the ECB data block 7. The DSP 25 loads the ECB data block 17 as the current ECB data block and further processes it.

The finder-process for the pointer structure is similar to the finder-process for the ECB data blocks.

After finding the pointer and the current ECB data block, the DSP 25 calculates further error correction bytes with data from image 13 or image 14′, thus, resulting in synchronization of image data transmission to the receiver 8 for real time imaging.

Because all the data for the image 13 may not be completely transmitted before power-off, image 13 may have low quality, detail or resolution. After power-on, when image 14′ is transmitted, image 14′ will contain measurement data used to create the image 13 and the image 14′ will overwrite the double part from the image 13 after decompression. The missing data is then added to image 13 in the database and surface display programs resulting in a high quality image.

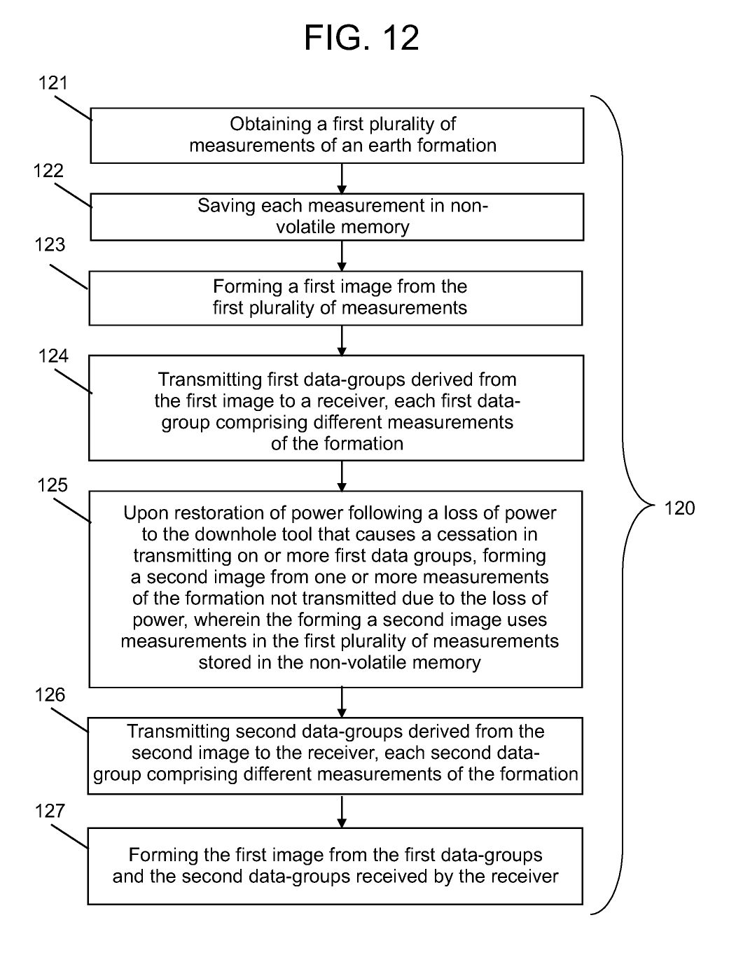

FIG. 12 presents one example of a method 120 for transmitting a first image from a downhole tool disposed in a borehole penetrating an earth formation to a receiver. In one embodiment, the image represents a complete resistivity image. The method 120 calls for (step 121) obtaining a first plurality of measurements of the earth formation using the tool to form a first dataset. Further, the method 120 calls for (step 122) saving data from the first plurality of measurements that form the first dataset in non-volatile memory. Further, the method 120 calls for (step 123) transmitting first data-groups derived fro the first dataset to the receiver, each of the first data-groups comprising different measurements. Further, the method 120 calls for (step 124) storing in the non-volatile memory a storage position of a last transmitted first data-group. Further, the method 120 calls for (step 125) upon restoration of a loss of communication that prevents transmission of all the first data-groups, determining the storage position of the last transmitted first data-group. Further, the method calls for (step 126) continuing the transmission of the first data-groups from the storage position of the first data-group last transmitted before the loss of communications.

It can be appreciated that more than one loss of power to the downhole tool 10 can occur before a complete resistivity image or dataset is received by the receiver 8. The techniques disclosed herein can be applied following the restoration of power after each loss of power until the complete resistivity image or dataset is received by the receiver 8. The claims are intended to include one or more loss of power events with subsequent restoration of power following each loss of power event.

It can be appreciated that a loss of power is just one example of a cause for a loss of communications from the downhole tool 10 to the receiver 8. Another cause of a loss of communication from the downhole tool 10 to the receiver 8 is a “downlink,” which is a transmission of information or commands from the receiver 8 to the downhole tool 10. Hence, the above discussions relating to a loss of power to the downhole tool 10 relate to a loss of communication from the downhole tool 10 to the receiver 8 due to any cause thereof

It can be appreciated that implementing the disclosed apparatus and method may be dependent on the type of telemetry system 9 being used. In embodiments using pulsed-mud telemetry, the process of detecting when the pumps used for this telemetry are off by a surface unit must be considered. The state of the pumps and hence the power state of the downhole BHA is detected by way of mud pressure measurements. The state “pumps off” is signaled when the measured pressure drops below the “pumps off” threshold for at least 30 seconds in one embodiment. That means, that the surface data acquisition unit (e.g., the receiver 8) will generate data words in the time between the pumps were switched off and the time where the “pumps off” state is detected. There is a certain probability that these data words will be decoded and marked as good. But, these data words have to be considered as bad or as useless because the data channel has to be considered as interrupted since the downhole BHA already has no electrical power and/or the mud flow is stopped. To address this problem and other similar problems, a “Block Interruption Pointer” (BIP), which is created by the downhole tool 10, is sent to the surface at the beginning of the run, after each restoration of power (i.e., restoration of communication to the surface), and after transmission channel interruption to the surface caused by a downlink. Based on this pointer, the surface data acquisition unit detects the position of the interruption in the data stream and the repeated data bytes to account for doubled data and any bad words generated within the “pumps off” phase in order to properly decompress the transmitted image.

The BIP is used to synchronize the surface data acquisition system with the transmission of data from the downhole tool 10. This signals includes information about the kind of transmission interruption (e.g., power interruption or downlink interruption), the number of the interrupted ECB, and the position in terms of byte number in the ECB, where the interruption happened. Because the number of bytes already sent with respect to the current ECB can be recovered, the pointer to the last sent bytes of image 13 can be calculated. In one embodiment, the BIP is a 16-bit uplink word, which is sent at least once at the beginning of transmission to the surface data acquisition unit, after restoration of power, and with the confirmation a received downlink. The BIP is used to initiate a resynchronization process and to determine the last received data byte before interruption of communication to the surface.

After an interruption of the transmission channel to the surface 9 (i.e., the receiver 8), the downhole tool 10 in one embodiment will repeat the last three bytes submitted before the interruption. These three bytes need to be detected within the data stream by the surface data acquisition unit. Because of several links in the whole transmission chain, up to three bytes, transmitted before the interruption could be flawless or lost/flawed. This leads to several combinations with correctly received bytes or lost/flawed bytes. The surface data acquisition unit is able to recover the ECB for all likely combinations of these modes by way of finding and deleting the bytes that were sent twice, correcting bit-errors by applying the Reed-Solomon-Decoding, and checking the ECB with a checksum.

It can be appreciated that while the techniques disclosed herein were presented using the master unit 21 and the imager 24, the functions of the master unit 21 and the imager 24 can be included in one electronic unit or distributed amongst a plurality of electronic units.

It can be appreciated that while the techniques disclosed herein were presented with respect to transmitting a resistivity image or dataset from the downhole tool 10 uphole to the receiver 8 (i.e., uplink), the techniques can also be used to transmit a data set from a surface location to the downhole tool 10 (i.e., downlink).

As discussed above and shown in FIG. 1, the downhole tool 10 is configured to be disposed in the borehole 2. In LWD/MWD applications, drilling mud is pumped through the center of the drill string 6 and the downhole tool 10 can be disposed in a collar surrounding the drill string 6. As such, the downhole tool 10 can be limited in space available for electronics, sensors, and the like. Thus, the amount of non-volatile memory can also be limited. It can be appreciated that the techniques disclosed herein provide for memory management of the non-volatile memory such as the EEPROM 22 in the master unit 21 or the NOR-Flash (i.e., the non-volatile memory 26) in the imager 24, hence, allowing use of limited size memory packages that can survive the high downhole temperatures.

In support of the teachings herein, various components may be used, including a digital and/or an analog system. For example, the master unit 21, the imager 24, the downhole tool 10, or the receiver 8 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers 14 include drill strings of the coiled tube type, of the jointed pipe type and any combination or portion thereof. Other carrier 14 examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order. The term “couple” relates to a device being directly coupled to another device or indirectly coupled through one or more intermediary devices.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for transmitting a first dataset from a tool to a receiver, the method comprising:
obtaining a first plurality of measurements using the tool to form a first dataset;
saving data from the first plurality of measurements that form the first dataset in non-volatile memory;
transmitting first data-groups derived from the first dataset to the receiver, each of the first data-groups comprising different measurements;
storing in the non-volatile memory a storage position of a last transmitted first data-group;
upon restoration of a loss of communications that prevents transmission of all the first data-groups, determining the storage position of the last transmitted first data-group; and
continuing the transmission of the first data-groups from the storage position of the first data-group last transmitted before the loss of communications.

2. The method according to claim 1, wherein the tool is a downhole tool configured to be disposed in a borehole penetrating an earth formation and the first plurality of measurements are measurements of the earth formation.

3. The method according to claim 1, wherein the storage position comprises at least one selection from a group consisting of: (a) saved transmitted data and calculated position of the saved transmitted data after the loss of communication, (b) flagged last transmitted data, and (c) saved address of the last transmitted data.

4. The method according to claim 1, further comprising transmitting after the loss of communication at least one first data-group that was previously transmitted before the loss of communications.

5. The method according to claim 4, wherein the at least one first data-group provides indication of a beginning of transmission of first-data groups not previously transmitted.

6. The method according to claim 1, further comprising transmitting a block interruption pointer (BIP) from the tool to the receiver upon the restoration of communications, the BIP comprising information about a kind of communications interruption and a position where the communications interruption occurred in an error correction block used to transmit the first data-groups to the receiver.

7. The method according to claim 1, further comprising:
obtaining a second plurality of measurements in order to form a second dataset;
saving each of the measurements in the second plurality of measurements that form the second dataset in the non-volatile memory;
upon restoration of the loss of communications that prevents transmission of all the first data-groups, forming a third dataset that includes measurements in the first plurality previously transmitted before the loss of communications and the second plurality of measurements not previously transmitted; and
transmitting third data-groups derived from the third dataset to the receiver.

8. The method according to claim 7, wherein:
the transmission of the first data-groups continues until performing measurements resumes when the loss of communications results in a halt in performing measurements; and
after resumption of performing measurements, starting transmission of the third data groups.

9. The method according to claim 1, wherein the first data groups are stored in the non-volatile memory.

10. The method according to claim 1, wherein the measurements comprise at least one selection from a group consisting of resistivity measurements, other electrical measurements, gamma ray measurements, sound measurements, nuclear measurements, and seismic measurements.

11. The method according to claim 10, wherein the first data set comprises an image of the measurements performed downhole.

12. The method according to claim 11, wherein the image of the downhole measurements comprises a plurality of image rows, each image row comprising a number of timestamp measurement groups, each timestamp measurement group comprising measurements selected from the first plurality of measurements and an associated timestamp.

13. The method according to claim 1, wherein the receiver is disposed at the surface of the earth.

14. The method according to claim 1, further comprising synchronizing the receiver to a data stream comprising the first data groups.

15. The method according to claim 14, wherein synchronizing comprises at least one of:
resending at least one first data group previously sent before the loss of communications to identify a beginning of transmission of first-data groups not previously transmitted; and
calculating all combinations of bytes of the sent first data groups and the resent first data groups to identify and eliminate communication bytes that were sent twice and to correct bit-errors.

16. The method according to claim 1, wherein the first data-groups comprise data compressed from the first plurality of measurements.

17. The method according to claim 1, wherein transmitting first data groups comprises encoding one of the first-data groups into error correction blocks comprising error correction information.

18. The method according to claim 1, wherein the loss of communications is caused by at least one of a power loss at the tool and a downlink from the receiver to the tool.

19. An apparatus for transmitting a first image from a tool to a receiver, the apparatus comprising:
a tool configured to obtain a first plurality of measurements;
a non-volatile memory disposed in the tool and configured to store the first plurality of measurements; and
at least one processor configured to:
form a first dataset from the first plurality of measurements;
transmit first data-groups derived from the first dataset to the receiver, each of the first data-groups comprising different measurements of the formation;
store in the non-volatile memory a storage position of a last transmitted first data-group;
upon restoration of a loss of communications that prevents transmission of all the first data-groups, determining the storage position of the last transmitted first data-group; and
continuing the transmission of the first data-groups from the storage position of the first data-group last transmitted before the loss of communications.

20. The apparatus according to claim 19, wherein the processor is further configured to transmit after the loss of communication at least one first data-group that was previously transmitted before the loss of communications.

21. The apparatus according to claim 19, wherein the processor is further configured to:
obtain a second plurality of measurements of the formation in order to form a second dataset;
save each of the measurements in the second plurality of measurements that form the second dataset in the non-volatile memory;
upon restoration of the loss of communications that prevents transmission of all the first data-groups, form a third dataset that includes measurements in the first plurality previously transmitted before the loss of communications and the second plurality of measurements not previously transmitted; and
transmit third data-groups derived from the third dataset to the receiver.

22. The apparatus according to claim 19, further comprising a carrier coupled to the tool and configured to be conveyed through a borehole penetrating an earth formation, wherein the tool is configured to perform measurements of the earth formation.
